(19) United States
(12) Patent Application Publication
(10) Pub. No.: US 2006/0071921 A1
(43) Pub. Date: Apr. 6, 2006

(54) Display apparatus and control method thereof

(75) Inventors: Heung-jun Park, Anyang-si (KR); Young-chan Kim, Euiwang (KR)

Correspondence Address: MCGUIREWOODS, LLP, 1750 TYSONS BLVD, SUITE 1800, MCLEAN, VA, 22102, US

(73) Assignee: Samsung Electronics Co., Ltd.

(21) Appl. No.: 11/239,141

(22) Filed: Sep. 30, 2005

(30) Foreign Application Priority Data
Oct. 1, 2004 (KR) 10-2004-0078381

(51) Int. Cl. G09G 5/00

(52) U.S. Cl. 345/204

(57) ABSTRACT

A display apparatus receiving a signal from a plurality of signal sources and outputting the signal to a display part, the display apparatus including a selection input part to select one of the plurality of signal sources as an input signal source; a memory to store information about the signal input from the signal source; and a controller that periodically detects the signal input from the plurality of signal sources, controls the memory to store the information about the detected signal, and sets the selected signal source as the input signal source on the basis of the information stored in the memory when the input signal source is selected through the selection input part.

### CROSS-REFERENCE TO RELATED APPLICATION

This application claims the benefit of Korean Patent Application No. 10-2004-0078381, filed on Oct. 1, 2004, in the Korean Intellectual Property Office, which is hereby incorporated by reference for all purposes as if fully set forth herein.

### BACKGROUND OF THE INVENTION

1. Field of the Invention

The present invention relates to a display apparatus and a control method thereof, and more particularly, to a display apparatus and a control method thereof, in which one of a plurality of signal sources is selected as an input signal source.

2. Description of the Related Art

A broadcast, a digital video disc (DVD), a component system, a personal computer, a memory card, and other audio/video devices serve as a signal source connected to a display apparatus and transmitting video and/or audio signals to the display apparatus. The signal output from such a signal source may have various formats, e.g., an analog signal, a digital signal, etc. Correspondingly, a signal processing method of the display apparatus varies according to the type of input signals and frequency characteristics.

In a conventional display apparatus, when a current set signal source is changed by another signal source, a scaler or a microcomputer generally detects a newly input signal and resets a register related thereto. The newly input signal is then processed according to the set register, thereby displaying a picture based on the newly input signal on a screen.

However, the conventional signal processing method requires operation and storage for setting a new input signal every time the current input signal source is changed with one of other signal sources, which is timely.

### SUMMARY OF THE INVENTION

An aspect of the present invention is to provide a display apparatus and a control method thereof, in which information about an input signal from a plurality of signal sources is previously stored, and an input signal source is set on the basis of the previously stored information when the current input signal source is changed with one of other signal sources, thereby reducing time taken to reset the input signal source.

Additional features of the invention will be set forth in the description which follows, and in part will be apparent from the description, or may be learned by practice of the invention

The present invention discloses a display apparatus receiving a signal from a plurality of signal sources and outputting the signal to a display part, the display apparatus including a selection input part to select one of the plurality of signal sources as an input signal source, a memory to store data relating to the signal input from the signal source, and a controller periodically detecting the signal input from the plurality of signal sources, controls the memory to store the data relating to the detected signal, and sets the selected signal source as the input signal source according to the data stored in the memory when the input signal source is selected through the selection input part.

The present invention further discloses a method of controlling a display apparatus receiving a signal from a plurality of signal sources and outputting the signal to a display part, the method including periodically detecting a signal input from the plurality of signal sources and storing data regarding the detected signal, and setting one of the plurality of signal source as an input signal source according to the stored data regarding the detected signal when the one of the plurality of signal sources is selected as the input signal source by a user.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a schematic control block diagram of a display apparatus according to an embodiment of the invention.

FIG. 2 is a control flowchart for setting a signal source for the display apparatus shown in FIG. 1.

FIG. 3 is a schematic control block diagram of a display apparatus according to another embodiment of the invention.

FIG. 4 is a control flowchart for setting a signal source for the display apparatus shown in FIG. 3.

FIG. 5 is a detailed control flowchart for setting the signal source for the display apparatus according to an embodiment of the invention.

### DESCRIPTION OF THE ILLUSTRATED EMBODIMENTS

Reference will now be made in detail to the embodiments of the present invention, examples of which are illustrated in the accompanying drawings, wherein like reference numerals refer to like elements throughout. The embodiments are described below in order to explain the present invention by referring to the figures.

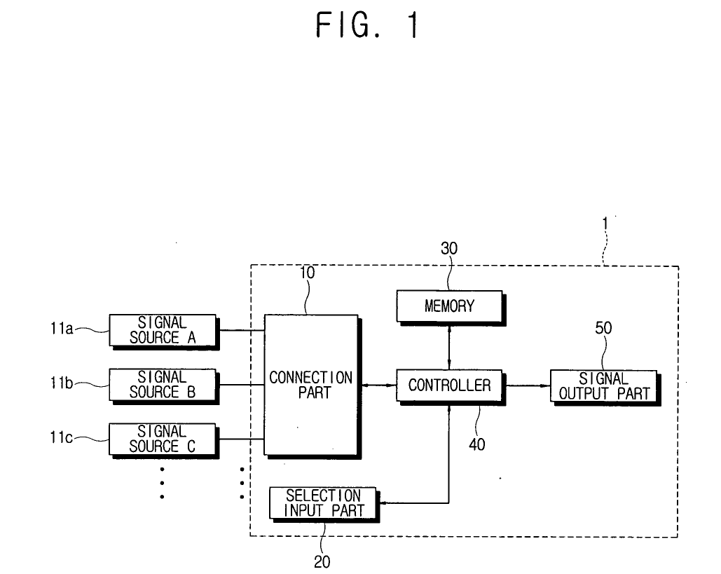

FIG. 1 is a schematic control block diagram of a display apparatus that may select and set one of an external signal source according to an embodiment of the invention.

As shown in FIG. 1, a display apparatus 1 includes a connection part 10 to which an external signal source 11a, 11b, 11c, . . . is connected, a controller 40 detecting a signal input through the connection part 10 and controlling a memory 30 to store information relating to the signal and setting an input signal source according to the information stored in the memory 30 when a user selects one of the plurality of external signal sources 11a, 11b, 11c, . . . through a selection input part 20, and a signal output part 50 outputting a processed signal.

The connection part 10 is an interface through which a signal is input from the plurality of external signal sources 11a, 11b, 11c, . . . . The configuration of the connection part 10 may vary according to the connected signal sources 11a, 11b, 11c, . . . .

For example, in the case of a DVD, a component system or the like, a connector terminal and a communication controller to be connected with a connector for data communication may be used as the connection part 10.

Further, in the case of a terrestrial broadcast, an antenna, a wave-guide, or the like may be used as the connection part 10.

Further, in the case of a memory card, a memory card slot, a data communication module, etc., may be used as the connection part 10.

Further, in the case of a personal computer, a D-sub connector, a DVI-I connector, a DVI-D connector, an HDMI connector, etc., may be used as the connection part 10.

The selection input part 20 allows a user to select one among the plurality of external signal sources 11a, 11b, 11c, . . . , and may be realized by a remote controller, a control panel, a keyboard, a touch screen, a voice recognition means, a mouse, etc.

The memory 30 stores the information regarding the input signal from the external signal sources 11a, 11b, 11c, . . . , and may be realized by a register of a microcomputer as the controller 40 as well as a random access memory (RAM), electrically erasable programmable read only memory (EEPROM), etc. The information stored in the memory 30 includes the signal source, the type of signal, or a frequency characteristic. When the register is used as the memory, the register is secured corresponding to each input signal source.

The controller 40 periodically detects the signal input from the plurality of signal sources and stores the information regarding the detected signal. Further, the controller 40 sets the input signal source according to the information stored in the memory 30 corresponding to a selection in the selection input part 20.

Here, the controller 40 may be realized by a multiplexer, a switching device, a microcomputer, etc. for selecting at least one of the plurality of input signals. The controller 40 may additionally include a scaler, a decoder, etc. to process a signal or an audio signal input from the signal source and output it to the signal output part 50. The more detailed operations of the controller 40 are described below.

The signal output part 50 outputs video and/or audio signals processed by the controller 40, and may be realized by an audio amplifier, a speaker, a liquid crystal display (LCD) module, a plasma display panel (PDP) module, a cathode ray tube (CRT) module, etc.

Meanwhile, when the input signal source changes, a menu for this change may be displayed as an on screen display (OSD).

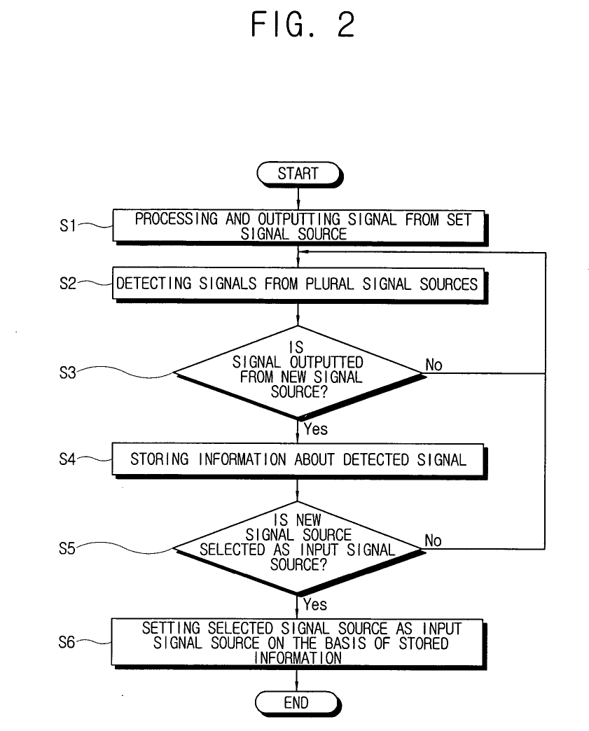

A control process of the display apparatus 1 according to the embodiment of the invention described above and shown in FIG. 1 is described below with reference to FIG. 2.

A signal input from a previously set input signal source is processed and displayed when the display apparatus 1 is turned on, as shown in operation S1.

The controller 40 periodically detects the signals input from the plurality of signal sources, as shown in operation S2. The period may vary according to designs of the display apparatus. Also, a sequence in which the signals are detected may be selected by a user or determined when the display apparatus is designed.

Whether the input signal is input from the currently set input signal source or another signal source is then determined, as shown in FIG. S3. When the input signal is not input from the currently set input signal but from a new signal source, the controller 40 stores the information relating to the detected signal in the memory 30, as shown in operation S4.

The controller 40 periodically repeats the foregoing detection and storage processes.

Upon determining that the input signal is input from the new signal source, a message corresponding to the determination may be displayed as the OSD to the signal output part 50, e.g., a display part.

This message displayed on the screen includes a menu related to the name of the signal source outputting the signal and selection of whether the input signal source will be changed. The input signal source may be selected through a hotkey corresponding to each signal source.

Whether a new signal source is selected as the input signal source is then determined, as shown in FIG. S5. When a user selects the new signal source as the input signal source through the selection input part 20, the controller 40 sets the input signal source according to the information stored in the memory 30, as shown in operation S6.

Here, a register value may be used as the information about the detected input signal. For example, the controller 40 calculates and stores the register value related to the detected signal, and sets the signal source selected by a user as the input signal source according to the corresponding register value when a command for changing the input signal source is input through the selection input part 20.

Therefore, the input signal source may be set on the basis of the previously stored information about the input signal, thereby reducing time taken to reset the input signal source.

The controller 40 may include a scaler and a microcomputer.

For example, the scaler detects the input signals from the plurality of signal sources, and stores information relating to the input signal as the register value.

The microcomputer transmits a command signal to the scaler in correspondence with a signal source change command from the selection input part 20, and the scaler sets the input signal source to be changed according to the register value stored corresponding to the command signal received from the microcomputer.

The scaler processes an input video signal according to the set register value.

Alternatively, the microcomputer may set the input signal source to be changed, and the scaler or the microcomputer may include a way of storing data.

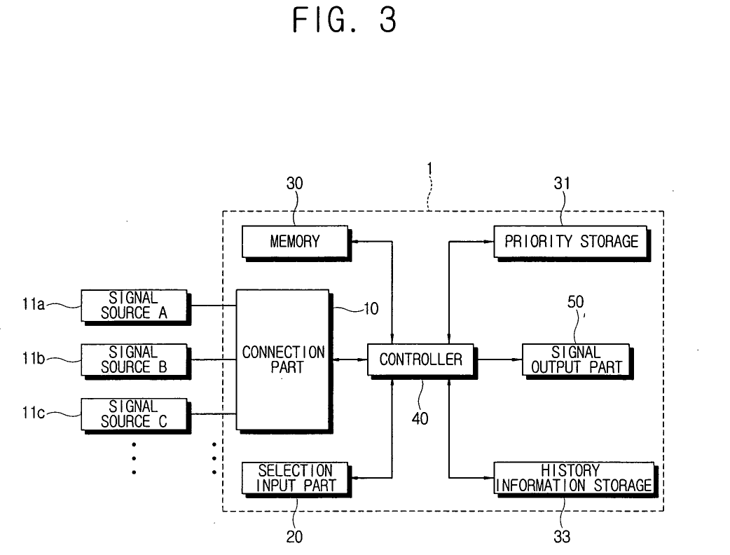

FIG. 3 is a schematic control block diagram of a display apparatus according to another embodiment of the invention, which may select and set one of external signal sources. For purposes of convenience, repetitive descriptions with regard to the embodiment described above and shown in FIG. 1 will be avoided as necessary.

As shown in FIG. 3, a display apparatus 1 includes a connection part 10 connected with an external signal source 11a, 11b, 11c, . . . , a selection input part 20, a memory 30, a priority storage 31, a history information storage 33, a controller 40, and a signal output part 50.

The priority storage 31 stores information regarding priority of the external signal sources, and the history information storage 33 stores history information regarding the external signal sources.

The priority storage 31 and the history information storage 33 may be realized by a register of a microcomputer as the controller 40, as well as a RAM, an EEPROM, etc. Further, the memory 30 storing the information relating to the input signal may be employed as the priority storage 31 and the history information storage 33.

The priority may be set by a user, or determined by calculation of the controller 40 according to the history information of the signal source. The controller 40 is described below in more detail.

The history information relates to use of the external signal source. For example, the history information may contain use data about what time each external signal source is selected by a user and used, duration each external signal source is used, etc.

The controller 40 determines the priority between the external signal sources by calculating the priority according to the use data stored in the history information storage 33, and then stores it in the priority storage 31. Further, the controller 40 may determine the sequence for detecting the external signal sources according to the history information stored in the history information storage 33.

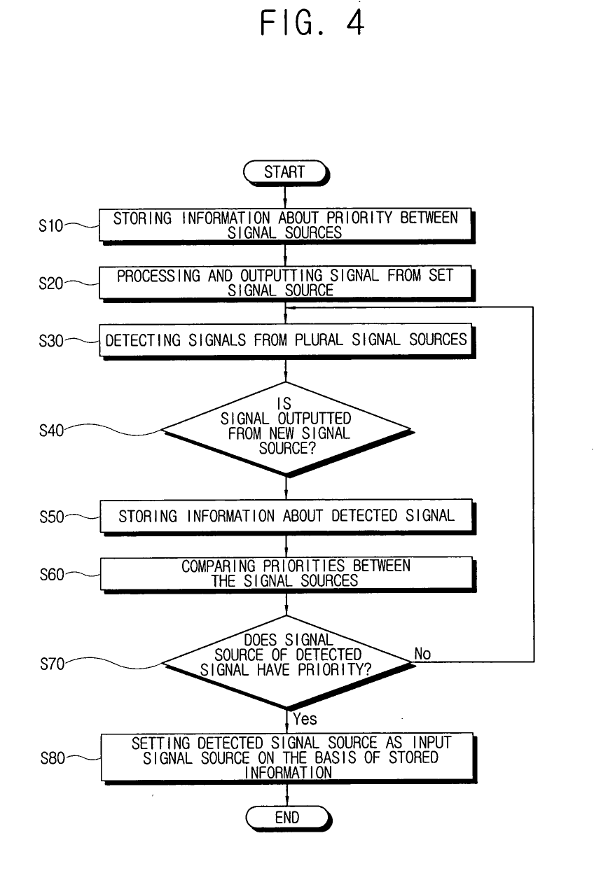

A control process of the display apparatus 1 according to the embodiment of the invention described above and shown in FIG. 3 is described with reference to FIG. 4. For purposes of convenience, repetitive descriptions with regard to the embodiment described above and shown in FIG. 3 will be avoided as necessary.

The controller 40 stores the information regarding the priority between the external signal sources in the priority storage 31, as shown in operation S10. When a user operates the selection input part 20 or selects the priority through an OSD of a display part, the controller 40 stores the priority information corresponding to the selection in the priority storage 31.

For example, when a user presses a predetermined button of a remote controller, the names or identifications of the external signal sources may be displayed on the display part so that a user may select the priority of the external signal source through the remote controller.

Alternatively, the priority may be not selected by a user but determined according to the use data of the external signal source stored in the history information storage 33. Further, a user may see the history information through the display part.

The subsequent operations S20 and S30 are the same as the operations S1 and S2 of the embodiment discussed above and shown in FIG. 2. Therefore, operations S20 and S30 are not discussed in detail.

Whether the input signal is input from the currently set input signal source or another signal source is then determined, as shown in operation S40. When the input signal is input from not the currently set input signal but the new signal source, the controller 40 stores the information relating to the detected signal in the memory 30, as shown in operation S50.

The controller 40 subsequently compares priorities between the signal sources according to the priority information stored in the priority storage 31, as shown in operation S60.

The controller 40 subsequently determines whether the detected signal has a higher priority than the currently set input signal, as shown in operation S70.

When the signal source detected corresponding to the input signal is determined to have a higher priority than the currently set input signal, the controller 40 sets the input signal source according to the information stored in the memory 30, as shown in operation S80.

In light of at least the embodiment of the invention described above and shown in FIG. 3 and FIG. 4, the input signal source is set according to the previously stored information relating to the detected signal, thereby reducing time taken to reset the input signal source.

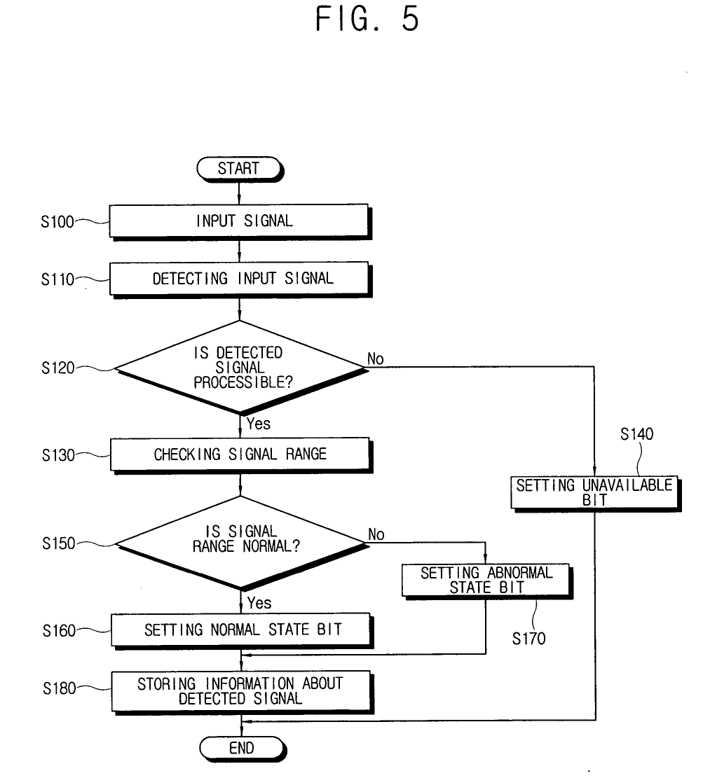

FIG. 5 is a control flowchart of storing information corresponding to a detected input signal from an external signal source.

When the signal is input from the external signal source in operation S100, the controller detects the input signal in operation S110.

The controller 40 determines whether the detected signal is processible, e.g., able to be processed, in the display apparatus 1, as shown in operation S120. When the detected signal is processible, the controller 40 determines the range of the detected signal, as shown in operation S130. However, when the detected signal is not processible, the controller 40 sets an unavailable bit, as shown in operation S140.

The controller 40 determines whether the range of the detected signal is normal or abnormal, as shown in operation S150. When the detected signal is within a normal range, a normal state bit is set, as shown in operation S160. However, when the detected signal is beyond the normal range, an abnormal state bit is set, as shown in operation S170.

The controller 40 stores/sets information or register relating to the signal source, a type of the signal source, frequency of the signal source, etc. according to the detected signal, as shown in operation S180.

When the normal state bit is set, the subsequent operation returns to the operation S60 of comparing the priorities (refer to FIG. 4).

Therefore, according to an embodiment of the invention, the display apparatus 1 periodically detects a signal from the plurality of signal sources, and stores the information about the detected signal so that the input signal source may be set according to priorities based on the data stored in the priority storage 31, thereby reducing time taken to reset the signal source.

As described above, the invention provides a display apparatus and a control method thereof, in which information about an input signal from a plurality of signal sources is previously stored, and an input signal source is set on the basis of the previously stored information when the current input signal source is changed with one of other signal sources, thereby reducing time taken to reset the input signal source.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents

What is claimed is:

1. A display apparatus receiving a signal from a plurality of signal sources and outputting the signal to a display part, the display apparatus comprising:
a selection input part to select one of the plurality of signal sources as an input signal source;
a memory to store data relating to the signal input from the signal source; and
a controller periodically detecting the signal input from the plurality of signal sources, controls the memory to store the data relating to the detected signal, and sets the selected signal source as the input signal source according to the data stored in the memory when the input signal source is selected through the selection input part.

2. The display apparatus according to claim 1, wherein the data relating to the detected signal comprises at least one of the data relating to the signal source, a type of signal, and a frequency characteristic.

3. The display apparatus according to claim 2, wherein the controller controls the display part to display a message relating to the new signal source through an on screen display when the input signal is detected from a new signal source and not from a currently set input signal source.

4. The display apparatus according to claim 2, further comprising:
a priority data storage storing data regarding priority between the plurality of signal sources,
wherein the controller sets one of the currently set input signal source and the new input signal source as the input signal source according to the priority data stored in the priority data storage when the input signal is input from a new signal source and not from the currently set input signal source.

5. The display apparatus according to claim 3, further comprising:
a priority data storage storing data regarding priority between the plurality of signal sources,
wherein the controller sets one of the currently set input signal source and the new input signal source as the input signal source according to the priority data stored in the priority data storage when the input signal is input from a new signal source and not from the currently set input signal source.

6. The display apparatus according to claim 4, wherein when a user selects the priority of the plurality of signal sources through the selection input part, and
wherein the controller stores the priority data about the selected priority in the priority data storage.

7. The display apparatus according to claim 4, further comprising:
a history data storage storing history data regarding the plurality of signal sources,
wherein the controller determines the priority of the plurality of the signal sources according to the history data stored in the history data storage, and
wherein the controller stores the data regarding the determined priority in the priority data storage.

8. A method of controlling a display apparatus receiving a signal from a plurality of signal sources and outputting the signal to a display part, the method comprising:
periodically detecting a signal input from the plurality of signal sources and storing data regarding the detected signal; and
setting one of the plurality of signal source as an input signal source according to the stored data regarding the detected signal when the one of the plurality of signal sources is selected as the input signal source by a user.

9. The method according to claim 8, wherein the data relating to the detected signal comprises at least one of the data relating to the signal source, a type of signal, and a frequency characteristic.

10. The method according to claim 9, further comprising
displaying a message relating to the new signal source when the input signal is detected from a new signal source and not from a currently set input signal source; and
setting one of the currently set input signal source and the new input signal source selected by the user through the displayed message as the input signal source.

11. The method according to claim 9, further comprising:
storing data regarding priority of the plurality of signal sources; and
setting one of the currently set input signal source and the new input signal source as the input signal source according to the stored priority data when the input signal is input from a new signal source and not from the currently set input signal source.

12. The method according to claim 11, wherein the priority is determined according to a user selection.

13. The method according to claim 11, wherein the priority is determined on the basis of history information about the plurality of signal sources.
